(19) United States
(12) Patent Application Publication
(10) Pub. No.: US 2007/0087952 A1
(43) Pub. Date: Apr. 19, 2007

(54) Floor stripper/cleaner containing aliphatic acid-organic base pair

(75) Inventors: Robert D.P. Hei, Baldwin, WI (US); Matthew P. Molinaro, Inver Grove Heights, MN (US); Minyu Li, Oakdale, MN (US)

Correspondence Address: Ann Kulprathipanja;KINNEY & LANGE, P.A., THE KINNEY & LANGE BUILDING, 312 South Third Street, Minneapolis, MN, 55415-1002, US

(73) Assignee: Ecolab Inc.

(21) Appl. No.: 11/254,235

(22) Filed: Oct. 18, 2005

(51) Int. Cl. C11D 3/00

(52) U.S. Cl. 510/214

(57) ABSTRACT

Floor finishes are stripped or deep scrubbed using a floor stripper/cleaner composition containing sparingly water-soluble floor finish solvent, water, C₁₀ aliphatic acid in an amount sufficient to provide a homogenous aqueous liquid phase during shaking, and sufficient organic amine so that the composition pH is more than 2 and less than 10 and the composition is not corrosive to skin.

### TECHNICAL FIELD

This invention relates to floor stripping, to the non-destructive removal of floor finishes, and to floor finish scrub and recoat procedures.

### BACKGROUND

Floor strippers are used to remove worn or discolored floor finishes from flooring substrates (e.g., vinyl composition tiles) so that a new finish may be applied. Floor scrub and recoat materials are used to carry out a procedure sometimes referred to as “deep scrubbing” so that a fresh layer of floor finish may be applied atop an existing floor finish. References relating to various stripping or cleaning agents (some of which are said to be floor strippers or floor cleaners) include U.S. Pat. No. 3,993,804 (McReady et al.) U.S. Pat. No. 4,187,191 (Simpson, Jr.), U.S. Pat. No. 5,080,831 (VanEenam '831), U.S. Pat. No. 5,342,551 (Ruckle), U.S. Pat. No. 5,419,848 (VanEenam '848), U.S. Pat. No. 5,637,559 (Koreltz et al.), U.S. Pat. No. 5,728,666 (Vitomar '666), U.S. Pat. No. 5,744,440 (Liu), U.S. Pat. No. 5,849,682 (VanEenam '682), U.S. Pat. No. 5,851,972 (Distaso et al.), U.S. Pat. No. 6,465,405 B1 (Vitomar '405), U.S. Pat. No. 6,544,942 B1 (Smith et al.), U.S. Pat. No. 6,583,101 B1 (Wiseth et al.) and U.S. Pat. No. 6,586,380 B2 (Marquis et al.), U.S. Patent Application Publication No. US 2003/0125226 A1 (Lewis), Published PCT Application Nos. WO 98/17734 (Brent International PLC) and WO 2004/090085 A1 (Vocfree, Inc.), Henkel Surface Technologies Technical Process Bulletin No. 238828 (Form Revised 4 Jun. 2001) and Benzyl Alcohol Paint Stripping, available on the Internet at http://p2library.nfesc.navy.mil/P2 Opportunity Handbook/5 9.html (Revision Date August 2003).

### SUMMARY OF THE INVENTION

Many floor strippers and floor scrub and recoat materials have a high pH, may irritate a user's skin, or may stain or otherwise damage linoleum and other substrates. Some strippers or scrub and recoat materials “dewet” (appear to bead up upon or otherwise insufficiently wet) a floor shortly after being applied, and may continue to dewet until the user swabs the applied material back and forth a few times. Some floor finishes (e.g., crosslinked floor finishes) are especially difficult to remove and may require multiple applications of a floor stripper formulation or long dwell times.

The present invention provides, in one aspect, a floor finish stripper or scrub and recoat composition comprising:
a) sparingly water-soluble floor finish solvent;
b) water;
c) C₁₀ aliphatic acid in an amount sufficient to provide a homogenous aqueous liquid phase during shaking; and
d) sufficient organic amine so that the composition pH is more than 2 and less than 10 and the composition is not corrosive to skin.

The invention provides in another aspect a method for stripping or deep scrubbing a floor finish comprising:
a) applying to the floor finish a composition comprising sparingly water-soluble floor finish solvent, water, C₁₀ aliphatic acid in an amount sufficient to provide a homogenous aqueous liquid phase during shaking, and sufficient organic amine so that the composition pH is more than 2 and less than 10 and the composition is not corrosive to skin;
b) allowing the applied composition to soften, dissolve or clean the floor finish; and
c) removing the composition.

The disclosed compositions and methods facilitate stripping or cleaning floor finishes. Preferred embodiments of the disclosed compositions and methods have a reduced pH and may be less irritating to skin or less likely to stain substrates such as linoleum. Additional preferred embodiments of the disclosed compositions and methods are substantially free of inorganic salts, and may be “greener” or more environmentally friendly than conventional compositions containing salts of acids as couplers.

### DETAILED DESCRIPTION

The phrase “hardenable floor finish” refers to an applied liquid coating that through a chemical or physical process (including solvent evaporation or other drying processes, photochemical reactions, electrochemical reactions, radical processes, thermal processes, ionic processes, moisture cure processes or multiple-component (e.g., two- or three-component) crosslinking processes) can become dried, crosslinked or otherwise cured in situ to form a tack-free film on a floor. The phrase “hardened floor finish” refers to such a dried, cross-linked or otherwise cured floor finish.

The phrase “stripping a floor finish” refers to removing, at such time as it may be desired to do so, a hardened floor finish from an underlying installed flooring substrate without removing substantial portions of the flooring substrate. Such stripping preferably employs minimally abrasive measures such as mop or spray application of the disclosed stripper/cleaner followed after a brief standing time by rinsing using, e.g., water or a detergent solution. Stripping may if desired be accompanied by more abrasive but flooring-safe measures such as abrading the finish during the standing time using, e.g., a nonwoven floor scrub pad, but may be carried out without requiring a flooring-damaging finish removal step such as sanding.

The phrases “deep scrubbing” and “scrubbing and recoating” refer to applying, at such time as it may be desired to do so, a composition containing a floor finish solvent to a hardened floor finish atop an underlying installed flooring substrate without removing all of the hardened floor finish, and cleaning the hardened floor finish surface sufficiently so that an additional layer or layers of hardenable floor finish may be applied thereto and hardened.

The word “concentrate” refers to a composition intended to be diluted with water before use. The phrase “substantially nonchlorinated” refers to a concentrate that does not contain objectionable quantities of chlorinated solvents (e.g., methylene chloride) whose presence might pose a health or environmental hazard. The phrase “floor finish solvent” refers to an organic liquid that can dissolve, soften or otherwise assist in removing a hardened floor finish from a floor, and includes organic cosolvents that assist in dissolving a solvent in a concentrate, help maintain the concentrate in a desirable physical state during storage, ease dilution of the concentrate with water, reduce cost, reduce odor or provide some other desirable packaging, storage or use benefit. The phrase “sparingly water-soluble” refers to a material that when mixed by itself with water at room temperature and pressure at a mixing ratio less than 1:20 will not form a clear, homogenous solution but which can form a clear, homogenous solution in the presence of sufficient acidic coupler.

The phrase “not corrosive to skin” refers to a composition which when tested with the CORROSITEX™ in-vitro skin corrosion assay from In Vitro International does not break through the assay membrane in less than sixty minutes of contact.

The phrase “homogenous aqueous liquid phase during shaking” refers to a composition that contains or is diluted to contain at least 75 wt. % water and which when 7.5 ml of such composition or diluted composition is placed in a 50 ml Erlenmeyer flask, manually shaken for one minute and allowed to stand for one minute will not completely separate into two or more phases.

A variety of sparingly water-soluble floor finish solvents may be employed in the disclosed compositions and methods. The solvent desirably has a flash point greater than about 60° C., low odor and low toxicity, and preferably has at least 0.1 wt. % water solubility. Representative floor finish solvents include 2-, 3- or 4-acetamidophenol (<1.4% water solubility); acetanilide (<1% water solubility); acetophenone (<1% water solubility); 2-acetyl-1-methylpyrrole; benzyl acetate (<1% water solubility); benzyl alcohol (˜4% water solubility); benzyl benzoate (<1% water solubility); benzyloxyethanol (<1% water solubility); ethers or hydroxyethers such as ethylene glycol phenyl ether (2.3% water solubility, commercially available as DOWANOL EPh™ from Dow Chemical Co.) and propylene glycol phenyl ether (1.1% water solubility, commercially available as DOWANOL PPh™ from Dow Chemical Co.); essential oils (e.g., benzaldehyde, pinenes (alphas, betas, etc.), terpineols, terpinenes, carvone, cinnamealdehyde, borneol and its esters, citrals, ionenes, jasmine oil, limonene, dipentene, linalool and its esters); dibasic esters such as dimethyl adipate, dimethyl succinate, dimethyl glutarate (often available in a mixture, including products available under the trade designations DBE™, DBE-3, DBE-4, DBE-5, DBE-6, DBE-9, DBE-IB, and DBE-ME from DuPont Nylon), dimethyl malonate, diethyl adipate, diethyl succinate, diethyl glutarate, dibutyl succinate, and dibutyl glutarate; dialkyl carbonates such as dimethyl carbonate, diethyl carbonate, dipropyl carbonate, diisopropyl carbonate, and dibutyl carbonate; C₁₋₁₂ organic anhydrides such as acetic anhydride, succinic anhydride, phthalic anhydride, maleic anhydride, and alkyl or alkenyl succinic anhydrides; organo-nitriles such as acetonitrile and benzonitrile; organo-phosphates and phosphonates such as tributyl phosphate, tripropyl phosphate, 2-ethyl-1-hexyl phosphate; phthalate esters such as dibutyl phthalate, diethylhexyl phthalate, and diethyl phthalate; and mixtures thereof. The water solubilities noted above are room temperature values. Some materials may serve as a solvent in some floor stripper/cleaner solutions or in some stripping applications, and as a cosolvent in combination with one or more solvents in other floor stripper/cleaner solutions or in other stripping applications. Additional representative solvents include amyl acetate, amyl alcohol, butanol, 3-butoxyethyl-2-propanol, butyl acetate, n-butyl propionate, cyclohexanone, diacetone alcohol, diethoxyethanol, diethylene glycol methyl ether, diisobutyl carbinol, diisobutyl ketone, dimethyl heptanol, dipropylene glycol tert-butyl ether, ethanol, ethyl acetate, 2-ethylhexanol, ethyl propionate, ethylene glycol methyl ether acetate, hexanol, isobutanol, isobutyl acetate, isobutyl heptyl ketone, isophorone, isopropanol, isopropyl acetate, methanol, methyl amyl alcohol, methyl n-amyl ketone, 2-methyl-1-butanol, methyl ethyl ketone, methyl isobutyl ketone, 1-pentanol, n-pentyl propionate, 1-propanol, n-propyl acetate, n-propyl propionate, propylene glycol ethyl ether, tripropylene glycol methyl ether (commercially available as DOWANOL TPM from Dow Chemical Co.), tripropylene glycol n-butyl ether (commercially available as DOWANOL TPNB from Dow Chemical Co.), diethylene glycol n-butyl ether acetate (commercially available as Butyl CARBITOL™ acetate from Dow Chemical Co.), diethylene glycol monobutyl ether (commercially available as Butyl CARBITOL from Dow Chemical Co.), ethylene glycol n-butyl ether acetate (commercially available as Butyl CELLOSOLVE™ acetate from Dow Chemical Co.), ethylene glycol monobutyl ether (commercially available as Butyl CELLOSOLVE from Dow Chemical Co.), dipropylene glycol monobutyl ether (commercially available as Butyl DIPROPASOL™ from Dow Chemical Co.), propylene glycol monobutyl ether (commercially available as Butyl PROPASOL™ from Dow Chemical Co.), ethyl 3-ethoxypropionate (commercially available as UCAR™ Ester EEP from Dow Chemical Co.), 2,2,4-Trimethyl-1,3-Pentanediol Monoisobutyrate (commercially available as UCAR FILMER™ IBT from Dow Chemical Co.), diethylene glycol monohexyl ether (commercially available as Hexyl CARBITOL from Dow Chemical Co.), ethylene glycol monohexyl ether (commercially available as Hexyl CELLOSOLVE from Dow Chemical Co.), diethylene glycol monomethyl ether (commercially available as Methyl CARBITOL from Dow Chemical Co.), diethylene glycol monoethyl ether (commercially available as CARBITOL from Dow Chemical Co.), ethylene glycol methyl ether acetate (commercially available as Methyl CELLOSOLVE acetate from Dow Chemical Co.), ethylene glycol monomethyl ether (commercially available as Methyl CELLOSOLVE from Dow Chemical Co.), dipropylene glycol monomethyl ether (commercially available as Methyl DIPROPASOL from Dow Chemical Co.), propylene glycol methyl ether acetate (commercially available as Methyl PROPASOL acetate from Dow Chemical Co.), propylene glycol monomethyl ether (commercially available as Methyl PROPASOL from Dow Chemical Co.), diethylene glycol monopropyl ether (commercially available as Propyl CARBITOL from Dow Chemical Co.), ethylene glycol monopropyl ether (commercially available as Propyl CELLOSOLVE from Dow Chemical Co.), dipropylene glycol monopropyl ether (commercially available as Propyl DIPROPASOL from Dow Chemical Co.) and propylene glycol monopropyl ether (commercially available as Propyl PROPASOL from Dow Chemical Co.). Preferred floor finish solvents include benzyl alcohol, dibasic esters, essential oils, dialkyl carbonates, ethylene glycol monobutyl ether, diethylene glycol monobutyl ether, ethylene glycol phenyl ether, propylene glycol phenyl ether and mixtures thereof. The floor finish solvent(s) (including cosolvent(s), if employed), may collectively represent for example at least 20%, at least 30%, at least 40%, at least 50%, at least 60%, at least 70%, at least 80% or at least 90% of the total concentrate weight.

Tap water, deionized water, distilled water or water in any other suitable form may be used in the disclosed compositions and methods. The use of softened water or of water having a low overall hardness level may facilitate application of the disclosed compositions to a hardened floor finish and limit dewetting. When the disclosed compositions are formulated as a concentrate, water may represent for example at least 5%, at least 10%, at least 20%, at least 30%, at least 40%, at least 50%, at least 60%, at least 70% or at least 80% of the total concentrate weight.

The C₁₀ aliphatic acid may contain heteroatoms (e.g., nitrogen or sulfur) and may be substituted with various moieties (e.g., hydroxyl, ester, aldehyde or alkyl groups), so long as such carbon atoms, heteroatoms and moieties do not interfere with solubilization of the floor finish solvent. N-decanoic acid is a preferred C₁₀ aliphatic acid. C₁₀ aliphatic acids of any suitable purity level may be employed. For example, a fatty acid containing 3 wt. % or more of a C₁₀ aliphatic acid such as coconut oil (5-10 wt. % n-decanoic acid) or palm kernel oil (3-7 wt. % n-decanoic acid) may be employed. Preferably however C₁₀ aliphatic acids of at least 50% purity are employed. When the disclosed compositions are formulated as a concentrate, the C₁₀ aliphatic acid may represent for example about 0.1 to about 20%, about 0.1 to about 10% or about 0.1 to about 5% of the total concentrate weight. The C₁₀ aliphatic acid may be accompanied by other acids (e.g., mineral acids, aromatic acids or aliphatic acids other than a C₁₀ aliphatic acid) or by salts of mineral, aromatic or aliphatic acids (e.g., sodium benzene sulfonate). However, the inclusion of acid salts or of other acids may make the stripper/cleaner less environmentally friendly, or less effective when used at a moderate pH. Preferably the C₁₀ aliphatic acid or acids are at least 50% of the total weight of acids and salts of acids. Acid couplers as described in copending Application Serial No. (attorney docket no. 117-P-2019US01) filed even date herewith, the disclosure of which is incorporated herein by reference, may also be employed in the disclosed compositions and methods.

A variety of organic amines may be employed in the disclosed compositions and methods. Representative organic amines include low molecular weight (e.g., C₁₋₁₂) organoamines and substituted organoamines (e.g., alkanolamines) such as monoethanolamine, diethyl ethanolamine, triethanolamine, N-benzylethanolamine, 2-aminomethylpropanol, furfurylamine, tetrahydrofurfurylamine and mixtures thereof. When the disclosed compositions are formulated as a concentrate, the organic amine may represent for example about 0.1 to about 20%, about 0.1 to about 10% or about 0.1 to about 5% of the total concentrate weight. The amine amount may also be expressed in terms of the molar equivalent ratio of acid to amine. For example, acid:amine molar equivalent ratios of about 0.5:1 to about 1.5:1 may be employed. Often it will be desirable to adjust the amine amount to obtain a desired pH in the final concentrate or use-solution. For example, the pH may be more than 2 and less than 10, more than 4 and less than 10, or more than 5 and less than 9. The use of excessive amine in the floor stripper/cleaner concentrate or use-solution can make the composition corrosive to skin, and can subject a concentrate having such corrosive properties to much more stringent packaging requirements. The organoamine may be accompanied by other amines (e.g., inorganic amines) or by salts of organic of inorganic amines. However, the inclusion of amine salts may make the stripper/cleaner less environmentally friendly, and the inclusion of inorganic amines may make the composition more prone to dewetting. Preferably the organoamines are at least 50% of the total weight of amines and salts of amines.

The disclosed compositions may also contain one or more surfactants. Representative surfactants will be familiar to those skilled in the art, and include anionic, cationic, amphoteric and nonionic surfactants, and mixtures thereof. Exemplary surfactants are described in U.S. Pat. No. 6,544,942 B 1. The amount of surfactant may vary depending on factors such as the types and amounts of other ingredients in the disclosed composition, the desired dilution level, and other factors that will be familiar to those skilled in the art. As a general guide, the amount of surfactant may be about 0.1 to about 20%, about 0.1 to about 15% or about 0.1 to about 10% of the total concentrate weight.

The disclosed compositions may contain other adjuvants including biocides, abrasive particles, chelants, builders, defoamers, fragrances, dyes, indicators, colorants, thickeners, anticorrosion additives, antirust additives, light stabilizers and antioxidants. The types and amounts of such adjuvants will be apparent to those skilled in the art.

The disclosed floor stripper/cleaners may be manufactured as concentrates intended to be diluted with water prior to use, or as ready-to-use solutions that may be employed without dilution. Desirably the floor stripper/cleaner forms a single phase when freshly stirred and maintains that single phase while stored in the container in which it will be sold, or at least for sufficient time (e.g., for one minute or more, two minutes or more, or five minutes or more) so that the composition may be stirred or otherwise mixed and then applied to a floor at the intended point of use before phase separation occurs. The concentrate may contain for example about 5 to about 85 wt. % solvent, about 1 to about 93 wt. % water, about 1 to about 25 wt. % C₁₀ aliphatic acid and about 1 to about 10 wt. % organic amine. A ready-to-use solution may contain for example about 0.05 to about 25 wt. % solvent, about 25 to about 99 wt. % water, about 0.01 to about 6 wt. % C₁₀ aliphatic acid and about 0.01 to about 3 wt. % organic amine.

The disclosed stripper/cleaners may be manufactured by mixing the ingredients in any convenient order. For example, the water, organic amine, surfactant (if employed), floor finish solvent, acid and any other desired ingredients (e.g., dyes, fragrances, chelating agents, etc.) may be mixed together. The disclosed stripper/cleaner may be packaged in any convenient form including bottles, drums, dispensers intended to be carried by a user during stripper/cleaner application and dispensers intended to be replaceably installed in a mixing or dispensing device (e.g., a wall-mounted, freestanding or benchtop dispensing station). The types and design of suitable packaging will be familiar to those skilled in the art.

A variety of flooring substrates may be stripped using the disclosed method. Exemplary flooring substrates include resilient flooring substrates such as vinyl composition tiles, vinyl sheet flooring, linoleum, rubber sheeting, rubber tile, cork, synthetic sports flooring and vinyl asbestos tile, and non-resilient flooring substrates such as terrazzo, concrete, wood flooring, bamboo, wood laminate, engineered wood products (e.g. wood epoxy blends, permanently coated substrates such as those available under the names PERGO™ and PARQUET™), stone, marble, slate, ceramic tile, grout, and dry shake flooring. Such flooring substrates may be installed at a variety of jobsites, including indoor and outdoor sites involving new or existing residential, commercial and government- or agency-owned sites.

A variety of hardened floor finishes may be stripped or deep scrubbed using the disclosed method. Representative commercially available floor finishes include PADLOCK™, GEMSTAR LASER™, GEMSTAR POLARIS™, RIVET™, and TAJ MAHAL™acrylic floor finishes, GLOSSTEK 100™ and ORION™ polyurethane floor finishes, and COURTMASTER II™, ISI STAR™, TUKLAR MEDICAL™ floor finishes, all from Ecolab Inc.; CORNERSTONE™ and TOPLINE™ acrylic floor finishes from 3M; BETCO BEST™ floor finish from Betco Corp.; HIGH NOON™ acrylic finish from Butchers; CITATION™ and CASTLEGUARD™ acrylic finishes from Buckeye International, Inc., COMPLETE™, SIGNATURE™, TECHNIQUE™ and VECTRA™ acrylic floor finishes from SC Johnson Professional Products; OVER AND UNDER™ floor sealer from S. C. Johnson Professional Products; SPLENDOR™, DECADE 90™, PRIME SHINE™ ULTRA and PREMIER™ acrylic finishes and FIRST ROUND and FORTRESS™ urethane acrylic finishes from Minuteman, International, Inc.; ACRYL-KOTE™ Seal and Finish and PREP Floor Seal from Minuteman, International, Inc.; ULTRA TC™ and UV I-FINISH™ UV-curable finishes from Minuteman, International, Inc; FLOORSTAR™ Premium 25 floor finish from ServiceMaster, Inc.; and UPPER LIMITS™ acrylic finish and ISHINE™ optically brightened floor finish from Spartan Chemical Co. Other suitable floor finishes may be based on film formers including No. AD200C1 polyester polyurethane formulation from Air Products and Chemicals, Inc.; LAROMER™ PE 22 WN polyester acrylate emulsion, LAROMER LR 8949 aqueous radiation curable aliphatic polyurethane dispersion and LAROMER LR 8983 aqueous radiation curable aromatic polyurethane dispersion, all from BASF Corp.; No. MG98-040 polyester polyurethane formulation from Bayer AG; MEGATRAN™ 205 zinc crosslinked acrylic dispersion and SYNTRAN™ 1580 zinc crosslinked acrylic dispersion from Interpolymer Corp.; MORGLO™ zinc crosslinked acrylic dispersion and MORGLO2™ acrylic styrene polymer emulsion, both from Omnova Solutions Inc.; STAY-CLAD™ 5900 hydroxyl-functional acrylic polymer dispersion from Reichhold, Inc.; DURAPLUS™ 2 modified acrylic low odor mixed-metal crosslinked polymer, DURAPLUS 3 zinc crosslinked acrylic dispersion, DURAGREEN™ MF1 metal free acrylic polymer emulsion, PRIMAL™ B-336AFK modified acrylic zinc crosslinked polymer, PRIMAL B-924ER zinc crosslinked, all acrylic polymer emulsion, PRIMAL E-2483 metal crosslinked acrylic polymer, PRIMAL E-3188 waterborne acrylic polymer dispersion, PRIMAL NT-2624 metal-free polymer, PRIMAL NT-6035 metal-free polymer, RHOPLEX™ B-924 all-acrylic metal-crosslinked floor polish polymer, RHOPLEX 1421 zinc crosslinked acrylic dispersion, RHOPLEX B-1604 metal-crosslinked modified acrylic polymer, RHOPLEX NT-2624 metal crosslinker-free modified acrylic polish, RHOPLEX 3479 low foaming metal-crosslinked modified acrylic polymer, ROSHIELD™ 3120 UV curable acrylate coating and UHS Plus™ metal-crosslinked modified acrylic polymer, all from Rohm & Haas Co.; VIAKTIN™ VTE 6155 aliphatic urethane acrylate, VTE 6165 aromatic urethane acrylate and VTE 6169 aliphatic polyester urethane radiation curing resins, all from Solutia, Inc.; Nos. 979-1 and 980-3 polyester polyurethane formulations from U.S. Polymers, Inc.; the ZVOC™ series of UV curable coatings from UV Coatings Limited; No. G-2029 acrylic polyurethane formulation and NEORAD™ NR-3709 UV curable aliphatic urethane coating from Zeneca Resins; 98-283W urethane acrylate from Hans Rahn & Co.; and materials such as those described in U.S. Pat. Nos. 4,517,330, 4,999,216, 5,091,211, 5,319,018, 5,453,451, 5,773,487, 5,830,937, 6,096,383, 6,197,844, 6,228,433. 6,316,535 B1, 6,544,942 B1, U.S. Patent Application Publication No. US 2002/0028621 A1, and in the patents cited therein. The floor finishes may include water-soluble or water-dispersible film formers such as metal-free acrylic finishes, acid-containing polymers crosslinked using transition metals, and water-soluble or water-dispersible multicomponent (e.g., two component) polyuretharies. The floor finish may contain mixtures of film formers.

If in concentrated form, the stripper/cleaner should be diluted with water prior to use, e.g., at an intended use location. Ordinary tap water, softened water or process water may be employed. The concentrate:water dilution ratio usually will be at least 1:1 by volume, for example at least 1:2, at least 1:3, at least 1:4, at least 1:5, at least 1:6, at least 1:8, at least 1:10 or more. A variety of mixing methods may be employed. Mixing in a mop bucket is one such method and may be preferred. The hardened floor finish can optionally be abraded with a suitably mild abrasive (e.g., a green or black SCOTCH-BRITE™ Floor Maintenance pad from 3M) prior to applying the stripper/cleaner. The stripper/cleaner may be applied using techniques that will be familiar to those skilled in the art (e.g., using a flat or string mop, squeegee, roller or towel). The applied stripper/cleaner should be allowed to stand for a suitable time (e.g., for a minute or more, and typically up to about 5, up to about 10 or up to about 20 minutes) while it softens or deep scrubs the floor finish. The composition (and, where stripping is intended, the softened finish) may be removed using a variety of techniques that will be familiar to those skilled in the art including vacuuming, mopping, scrubbing or wiping. The stripped floor or deep scrubbed floor finish may be allowed to dry and a layer or layers of floor finish applied thereto and caused or allowed to harden.

The invention is further illustrated in the following non-limiting examples, in which all parts and percentages are by weight unless otherwise indicated.

### EXAMPLE 1

A series of concentrates was made using the ingredients and weight percentage amounts shown below in Table 1a and 1b. The acid amounts were adjusted to provide a 0.8:1 (see Table 1a) or 1.2:1 (see Table 1b) equivalent ratio of acid:amine.

TABLE 1a

| Ingredient | Run 1-1, % | Run 1-2, % | Run 1-3, % | Run 1-4, % | Run 1-5, % | Run 1-6, % |
|---|---|---|---|---|---|---|
| Monoethanolamine | 2.5 | 2.5 | 2.5 | 2.5 | 2.5 | 2.5 |
| Ethylene glycol | 10.0 | 10.0 | 10.0 | 10.0 | 10.0 | 10.0 |
| phenyl ether¹ | | | | | | |
| Diethylene glycol | 6.0 | 6.0 | 6.0 | 6.0 | 6.0 | 6.0 |
| monobutyl ether² | | | | | | |
| 40% active sodium | 20.0 | 20.0 | 20.0 | 20.0 | 20.0 | 20.0 |
| xylene sulfonate³ | | | | | | |
| Linear alcohol | 2.0 | 2.0 | 2.0 | 2.0 | 2.0 | 2.0 |
| ethoxylate⁴ | | | | | | |
| Lactic acid (C₃) | 3.4 | | | | | |
| Octanoic acid (C₈) | | 4.9 | | | | |
| Isononanoic acid (C₉) | | | 5.1 | | | |
| Decanoic acid (C₁₀) | | | | 5.8 | | |
| Coconut fatty acid | | | | | 7.4 | |
| (primarily C₁₂ and C₁₄) | | | | | | |
| tall oil fatty acid | | | | | | 10.3 |
| (primarily C₁₈ and C₁₆) | | | | | | |
| Water, softened | 56.1 | 54.6 | 54.4 | 53.7 | 52.1 | 49.2 |

¹DOWANOL ™ EPh from Dow Chemical Co.
²Butyl CARBITOL ™ from Dow Chemical Co.
³STEPANATE ™ SXS from Stepan Chemical Co.
⁴SURFONIC L12-6 from Huntsman Chemical Co.

TABLE 1b

| Ingredient | Run 1-7, % | Run 1-8, % | Run 1-9, % | Run 1-10, % | Run 1-11, % | Run 1-12, % |
|---|---|---|---|---|---|---|
| Monoethanolamine | 2.5 | 2.5 | 2.5 | 2.5 | 2.5 | 2.5 |
| Ethylene glycol | 10.0 | 10.0 | 10.0 | 10.0 | 10.0 | 10.0 |
| phenyl ether | | | | | | |
| Diethylene glycol | 6.0 | 6.0 | 6.0 | 6.0 | 6.0 | 6.0 |
| monobutyl ether | | | | | | |
| 40% active sodium | 20.0 | 20.0 | 20.0 | 20.0 | 20.0 | 20.0 |
| xylene sulfonate | | | | | | |
| Linear alcohol | 2.0 | 2.0 | 2.0 | 2.0 | 2.0 | 2.0 |
| ethoxylate | | | | | | |
| Lactic acid (C₃) | 5.0 | | | | | |
| Octanoic acid (C₈) | | 7.0 | | | | |
| Isononanoic acid (C₉) | | | 7.9 | | | |
| Decanoic acid (C₁₀) | | | | 8.4 | | |
| Coconut fatty acid | | | | | 10.7 | |
| (primarily C₁₂ and C₁₄) | | | | | | |
| tall oil fatty acid | | | | | | 14.9 |
| (primarily C₁₈ and C₁₆) | | | | | | |
| Water, softened | 54.5 | 52.5 | 51.6 | 51.1 | 48.8 | 44.6 |

The resulting concentrates were diluted with tap water at a 1:6 ratio by volume to form floor stripper/cleaner use-solutions containing about 0.5% amine (monoethanolamine) and 2.5% solvents (ethylene glycol phenyl ether and diethylene glycol monobutyl ether). The use-solutions were applied to tiles coated with 4 layers of ZINC FREE FLOOR FINISH from Ecolab Inc. which had been applied at a 50 m²/L (2000 ft²/gallon) coating rate. Foam rings were adhered to the tiles to provide similar enclosed circular areas. Each use-solution was placed inside a ring for a 5 minute or 10 minute contact time. The foam rings were removed, and the tiles rinsed with water. Stripping effectiveness was visually evaluated. The results are set out below in Table 1c and Table 1d.

TABLE 1c

| | Acid added | | | | | |
|---|---|---|---|---|---|---|
| | at 0.8:1 | Use- | Visual | | Visual | |
| Run | acid:amine | solution | assessment 5 | | assessment 10 | |
| No. | ratio | pH | minute contact | | minute contact | |
| 1-1 | Lactic acid | 9.63 | 0-10% | removal | 10-25% | removal |
| 1-2 | Octanoic acid | 9.35 | 0-10% | removal | 25-50% | removal |
| 1-3 | Isononanoic | 9.30 | 10-25% | removal | 25-50% | removal |
| | acid | | | | | |
| 1-4 | Decanoic acid | 9.1 | 25-50% | removal | 75-100% | removal |
| 1-5 | Coconut | 9.24 | 0-10% | removal | 10-25% | removal |
| | fatty acid | | | | | |
| 1-6 | Tall oil | 9.46 | 0-10% | removal | 0-10% | removal |
| | fatty acid | | | | | |

TABLE 1d

| | Acid added | | | | | |
|---|---|---|---|---|---|---|
| | at 1.2:1 | Use- | Visual | | Visual | |
| Run | acid:amine | solution | assessment 5 | | assessment 10 | |
| No. | ratio | pH | minute contact | | minute contact | |
| 1-7 | Lactic acid | 5.6 | 0% | removal | 0% | removal |
| 1-8 | Octanoic acid | 7.2 | 0-10% | removal | 10-25% | removal |
| 1-9 | Isononanoic | 7.35 | 0-10% | removal | 0-10% | removal |
| | acid | | | | | |
| 1-10 | Decanoic acid | 7.75 | 10-25% | removal | 75-100% | removal |
| 1-11 | Coconut | 7.65 | 0-10% | removal | 10-25% | removal |
| | fatty acid | | | | | |
| 1-12 | Tall oil | 7.45 | 0-10% | removal | 10-25% | removal |
| | fatty acid | | | | | |

After a 10 minute contact time, the decanoic acid floor stripper/cleaner removed nearly all of the finish from the tile, while the other floor stripper/cleaners did not. The decanoic acid formulations also retained their effectiveness at an approximately neutral pH.

### EXAMPLE 2

Using the method of Example 2 and the amounts shown below in Table 2a, three concentrated floor stripper/cleaner formulations were prepared:

TABLE 2a

| Ingredient | Run 2-1, % | Run 2-2, % | Run 2-3, % |
|---|---|---|---|
| Water, softened | 53.7 | 52.5 | 60.5 |
| Monoethanolamine | 2.5 | 2.5 | 2.5 |
| Ethylene glycol | 10.0 | 10.0 | 7.0 |
| phenyl ether | | | |
| Diethylene glycol | 6.0 | 6.0 | 6.0 |
| monobutyl ether | | | |
| 40% active sodium | 20.0 | 20.0 | 15.0 |
| xylene sulfonate | | | |
| Linear alcohol ethoxylate | 2.0 | 2.0 | 2.0 |
| Decanoic acid (C₁₀) | 5.8 | 7.0 | 7.0 |

The resulting concentrates were diluted with tap water at a 1:6 ratio by volume to form floor stripper/cleaner use-solutions containing about 0.4% amine (monoethanolamine) and 1.6% (Run Nos. 2-1 and 2-2) or 1.1% (Run No. 2-3) ethylene glycol phenyl ether. The use-solutions were placed inside foam rings placed on tiles coated as in Example 1 and evaluated for 5 and 10 minute contact times. Stripping effectiveness was visually evaluated. The results are set out below in Table 2b.

TABLE 2b

| | Visual assessment | Visual assessment | |
|---|---|---|---|
| Run No. | 5-minute contact | 10-minute contact | |
| Run 2-1 | 25-50% removal | 75-100% | removal |
| Run 2-2 | 25-50% removal | 75-100% | removal |
| Run 2-3 | 10-25% removal | 50-75% | removal |

Comparable stripping results were observed at both acid:amine ratios, and better stripping results were observed at higher solvent content.

### EXAMPLE 3

Three floor stripper/cleaner concentrates were made using the ingredients and amounts shown below in Table 3a:

TABLE 3a

| Ingredient | Run 3-1, % | Run 3-2, % | Run 3-3, % |
|---|---|---|---|
| Water | 51.1 | 62.1 | 58.5 |
| Monoethanolamine | 2.5 | 9.6 | |
| Triethanolamine (85%) | | | 20 |
| Decanoic acid | 8.4 | | |
| Lactic acid | | 9.4 | |
| Ethylene glycol | 10.0 | 3.5 | 5.0 |
| phenyl ether | | | |
| Diethylene glycol | 6.0 | 4.6 | 6.0 |
| monobutyl ether | | | |
| Sodium xylene sulfonate | 20.0 | 9.8 | |
| Propylene glycol | | | 10 |
| Linear alcohol | 2.0 | | |
| ethoxylate¹ | | | |
| Linear alcohol | | 1.0 | 0.5 |
| ethoxylate² | | | |

¹SURFONIC L12-6 from Huntsman Performance Products.
²SURFONIC L24-7 from Huntsman Performance Products.

The concentrates were tested with the CORROSITEX™ in-vitro skin corrosion assay from InVitro International. In this assay, a color-changing fluid is placed beneath a biomembrane which provides a color change signal when a corrosive material degrades the membrane. Materials are considered corrosive if they break through the membrane in less than sixty minutes of contact. The assay uses a sodium hydroxide solution as a negative control. The assay results are shown below in Table 3b.

TABLE 3b

| | | Skin Corrosion |
|---|---|---|
| Formulation | Concentrate pH | Assay Result |
| Run 3-1 | 7.5 | NOT CORROSIVE |
| | | (Not DOT Regulated) |
| Run 3-2 | 10.0 | CORROSIVE |
| | | (DOT Packing group III) |
| Run 3-3 | 9.5 | CORROSIVE |
| | | (DOT Packing group III) |
| Sodium Hydroxide | >13 | CORROSIVE |
| solution | | (DOT Packing group II) |

As shown in Table 3b, the Run 3-1 floor stripper/cleaner was not corrosive in the skin corrosion assay, and could be shipped without requiring DOT-approved packaging.

### EXAMPLE 4

Two floor stripper concentrates like those shown in Table A of U.S. Pat. No. 5,637,559 were made using the ingredients and amounts shown below in Table 4a:

TABLE 4a

| Ingredient | Concentrate 1, % | Concentrate 2, % |
|---|---|---|
| Benzyl alcohol | 39.9 | 37.9 |
| Monoethanolamine (99%) | 33.9 | 33.9 |
| n-Octanoic acid (>95%) | 25.0 | 25.0 |
| Fluorinated wetting aid¹ | 0.20 | 0.20 |
| Tetrasodium EDTA² | 0.50 | 0.50 |
| Dye | 0.50 | 0.50 |
| d-Limonene | | 2.00 |

¹ZONYL ™ FSN from E. I. du Pont de Nemours and Company.
²DISOLVINE ™ 100-S from Akzo Nobel Chemicals.

The pH values for Concentrate 1 and Concentrate 2 as made and at a 1:10 by volume dilution with water were measured using a pH meter. The appearance of each use-solution was also determined by visual inspection. The results are shown below in Table 4b, along with comparison data for the Run 3-1 concentrate and 1:6 and 1:10 diluted use-solutions:

TABLE 4b

| | | Dilution | | Diluted |
|---|---|---|---|---|
| | pH of | Ratio with | Diluted Use- | Use-Solution |
| | Concentrate | Water | Solution pH | Appearance |
| Concentrate 1 | 11.2 | 1:10 | 10.3 | Cloudy, |
| | | | | White |
| Concentrate 2 | 11.1 | 1:10 | 10.3 | Cloudy, |
| | | | | White |
| Run 3-1 | 7.5 | 1:10 | 7.6 | Clear |
| Run 3-1 | 7.5 | 1:6 | 7.6 | Clear |

The monoethanolamine amount and pH values for Concentrate 1 and Concentrate 2 appear to be sufficient to make these concentrates corrosive to skin and to require DOT-approved packaging. The Run 3-1 concentrate had a neutral pH (pH 5-9) in both concentrated and diluted form. As shown above, the Run 3-1 concentrate is not corrosive to skin and could be sold without DOT-approved packaging.

Various modifications and alterations of this invention will be apparent to those skilled in the art without departing from the scope and spirit of this invention. It should be understood that this invention is not limited to the illustrative embodiments set forth above.

We claim:

1. A floor finish stripper or scrub and recoat composition comprising:
a) sparingly water-soluble floor finish solvent;
b) water;
c) C₁₀ aliphatic acid in an amount sufficient to provide a homogenous aqueous liquid phase during shaking; and
d) sufficient organic amine so that the composition pH is more than 2 and less than 10 and the composition is not corrosive to skin.

2. A composition according to claim 1 wherein the solvent comprises a dibasic ester, essential oil, dialkyl carbonate or mixture thereof.

3. A composition according to claim 1 wherein the solvent comprises ethylene glycol monobutyl ether, diethylene glycol monobutyl ether, ethylene glycol phenyl ether, propylene glycol phenyl ether, or mixture thereof.

4. A composition according to claim 1 wherein the solvent comprises benzyl alcohol.

5. A composition according to claim 1 wherein the C₁₀ aliphatic acid comprises n-decanoic acid.

6. A composition according to claim 1 wherein the amine comprises monoethanolamine.

7. A composition according to claim 1 further comprising surfactant.

8. A composition according to claim 1 having a pH more than 4 and less than 10.

9. A composition according to claim 1 having a pH more than 5 and less than 9.

10. A composition according to claim 1 comprising about 5 to about 85 wt. % solvent, about 1 to about 93 wt. % water, about 1 to about 25 wt. % C₁₀ aliphatic acid and about 1 to about 10 wt. % organic amine.

11. A method for stripping or deep scrubbing a floor finish comprising:
a) applying to the floor finish a composition comprising sparingly water-soluble floor finish solvent, water, C₁₀ aliphatic acid in an amount sufficient to provide a homogenous aqueous liquid phase during shaking, and sufficient organic amine so that the composition pH is more than 2 and less than 10 and the composition is not corrosive to skin;
b) allowing the applied composition to soften, dissolve or clean the floor finish; and
c) removing the composition.

12. A method according to claim 11 wherein the solvent comprises a dibasic ester, essential oil, dialkyl carbonate or mixture thereof.

13. A method according to claim 11 wherein the solvent comprises ethylene glycol monobutyl ether, diethylene glycol monobutyl ether, ethylene glycol phenyl ether, propylene glycol phenyl ether, or mixture thereof.

14. A method according to claim 11 wherein the solvent comprises benzyl alcohol.

15. A method according to claim 11 wherein the C₁₀ aliphatic acid comprises n-decanoic acid.

16. A method according to claim 11 wherein the amine comprises monoethanolamine.

17. A method according to claim 11 wherein the composition further comprises surfactant.

18. A method according to claim 11 wherein the composition has a pH more than 4 and less than 10.

19. A method according to claim 11 wherein the composition has a pH more than 5 and less than 9.

20. A method according to claim 11 wherein the composition contains about 0.05 to about 25 wt. % solvent, about 25 to about 99 wt. % water, about 0.01 to about 6 wt. % C₁₀ aliphatic acid and about 0.01 to about 3 wt. % organic amine.
